(19) United States
(12) Patent Application Publication
(10) Pub. No.: US 2022/0198328 A1
(43) Pub. Date: Jun. 23, 2022

(54) INFORMATION PROCESSING METHOD, INFORMATION PROCESSING DEVICE, AND PROGRAM

(71) Applicant: TOYOTA JIDOSHA KABUSHIKI KAISHA, Toyota-shi (JP)

(72) Inventor: Noriyuki SASAKI, Toyota-shi (JP)

(73) Assignee: TOYOTA JIDOSHA KABUSHIKI KAISHA, Toyota-shi (JP)

(21) Appl. No.: 17/491,847

(22) Filed: Oct. 1, 2021

(30) Foreign Application Priority Data
Dec. 17, 2020 (JP) 2020-209615

(51) Int. Cl. G06N 20/00

(52) U.S. Cl. CPC G06N 20/00

(57) ABSTRACT

An information processing method includes: acquiring behavioral history information on an inference target user; acquiring an inferred value of a characteristic relating to the consumption behavior of the inference target user as an output in response to an input of the behavioral history information on the inference target user into a first learned model that has been learned using first learning data about a plurality of learning target users, the first learning data having, as an input, behavioral history information on each learning target user and, as an output, a characteristic relating to the consumption behavior of the learning target user based on answers to a questionnaire given by the learning target user; and based on the inferred value of the characteristic relating to the consumption behavior of the inference target user, outputting an action that is inferred to be effective for the inference target user.

### CROSS-REFERENCE TO RELATED APPLICATION

This application claims priority to Japanese Patent Application No. 2020-209615 filed on Dec. 17, 2020, incorporated herein by reference in its entirety.

### BACKGROUND

### 1. Technical Field

This disclosure relates to an information processing method, an information processing device, and a program.

### 2. Description of Related Art

There is a disclosed technique that involves classifying each of a plurality of target users into one of a plurality of properties based on their answers to a questionnaire, designating a target user whose behavioral history meets a predetermined criterion as a teacher user, and creating a learned model that has been learned using the behavioral history and the property of the teacher user (e.g., Japanese Unexamined Patent Application Publication No. 2020-035409). By using the learned model and a behavioral history of a user to be inferred, the property of the user to be inferred can be inferred.

### SUMMARY

An object of one aspect of this disclosure is to provide an information processing method, an information processing device, and a program that can propose an effective action appropriate for each user.

One aspect of this disclosure is an information processing method including:

acquiring behavioral history information on an inference target user;

acquiring an inferred value of a characteristic relating to consumption behavior of the inference target user as an output in response to an input of the behavioral history information on the inference target user into a first learned model that has been learned using first learning data about a plurality of learning target users, the first learning data having, as an input, behavioral history information on each of the learning target users and, as an output, a characteristic relating to consumption behavior of the learning target user based on answers to a questionnaire given by the learning target user; and

based on the inferred value of the characteristic relating to the consumption behavior of the inference target user, outputting an action that is inferred to be effective for the inference target user.

Another aspect of this disclosure is an information processing device including a control unit that executes:

acquiring behavioral history information on an inference target user;

acquiring an inferred value of a characteristic relating to consumption behavior of the inference target user as an output in response to an input of the behavioral history information on the inference target user into a first learned model that has been learned using first learning data about a plurality of learning target users, the first learning data having, as an input, behavioral history information on each of the learning target users and, as an output, a characteristic relating to consumption behavior of the learning target user based on answers to a questionnaire given by the learning target user; and

based on the inferred value of the characteristic relating to the consumption behavior of the inference target user, outputting an action that is inferred to be effective for the inference target user.

Yet another aspect of this disclosure is a program that causes a computer to execute:

acquiring behavioral history information on an inference target user;

acquiring an inferred value of a characteristic relating to consumption behavior of the inference target user as an output in response to an input of the behavioral history information on the inference target user into a first learned model that has been learned using first learning data about a plurality of learning target users, the first learning data having, as an input, behavioral history information on each of the learning target users and, as an output, a characteristic relating to consumption behavior of the learning target user based on answers to a questionnaire given by the learning target user; and

based on the inferred value of the characteristic relating to the consumption behavior of the inference target user, outputting an action that is inferred to be effective for the inference target user.

According to this disclosure, an effective action appropriate for each user can be proposed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is one example of a chart showing a flow of inference of an action in an action inference system according to a first embodiment;

FIG. 2 is a chart showing one example of the hardware configuration of an information processing device;

FIG. 3 is a chart showing one example of the functional configuration of the information processing device;

FIG. 4 is one example of Web browsing access log data;

FIG. 5 is one example of a site classification master;

FIG. 6 is one example of data of answers to a questionnaire on a sense of values and a tendency of consumption behavior;

FIG. 7 is one example of data of answers to a questionnaire on evaluations of measures;

FIG. 8 is one example of integrated data that serves as learning data for a cluster inference model;

FIG. 9 is a chart showing one example of input data and output data in learning of the cluster inference model;

FIG. 10 is one example of integrated data that serves as learning data for a measure inference model;

FIG. 11 is a chart showing one example of input data and output data for the measure inference model;

FIG. 12 is one example of a flowchart of a learning process of the cluster inference model and the measure inference model in the action inference system;

FIG. 13 is one example of a flowchart of an inference control process in the action inference system; and

FIG. 14 is one example of a chart showing a flow of inference of an action in an action inference system according to a modified example.

### DETAILED DESCRIPTION OF EMBODIMENTS

One aspect of this disclosure is an information processing method. The information processing method is executed by, for example, a computer, such as a server. The information processing method includes: acquiring behavioral history information on an inference target user; acquiring an inferred value of a characteristic relating to the consumption behavior of the inference target user as an output in response to an input of the behavioral history information on the inference target user into a first learned model; and, based on the inferred value of the characteristic relating to the consumption behavior of the inference target user, outputting an action that is inferred to be effective for the inference target user. The first learned model has been learned using first learning data about a plurality of learning target users that has, as an input, behavioral history information on each learning target user and, as an output, a characteristic relating to the consumption behavior of the learning target user based on answers to a questionnaire given by the learning target user.

The learning target user is a user who is a target of the learning data for the learned model. The inference target user is a user who is a target of inference using the learned model. The behavioral history information is, for example, Web page browsing access log data. However, the behavioral history information is not limited to Web page browsing access log data and may instead be Web page search log data. The behavioral history information is not limited to behavioral history information on the Web and may instead be history information on behavior in the real world. Examples of behavior in the real world that is used as the behavioral history information include visiting a real shop and making a purchase.

Examples of the characteristic relating to consumption behavior include a sense of values about a product or a service to be purchased and a tendency of consumption behavior. The sense of values about a product or a service to be purchased means what a user attaches importance to in making a purchase. For example, some users attach importance to the brand while other users attach importance to the functionality. Still other users attach importance to the cost performance or being ecological. Examples of the tendency of consumption behavior include a tendency in terms of the time taken to make a purchase, such as whether the user makes a quick decision or a deliberate decision, and a tendency in terms of the consideration method, such as whether the user decides by himself or herself or asks someone's opinion when making a purchase.

The characteristic relating to consumption behavior is reflected in the behavioral history information that is information showing objective facts. In one aspect of this disclosure, therefore, the first learned model is used that has been learned using the first learning data that has, as an input, behavioral history information on each learning target user and, as an output, a characteristic relating to the consumption behavior acquired based on answers to a questionnaire given by the learning target user, which are subjective information. Thus, a characteristic relating to the consumption behavior of the inference target user can be inferred from the behavioral history information on the inference target user.

Examples of the action that is inferred to be effective for the inference target user include actions for sales promotion and actions for product planning. Examples of actions for sales promotion include deciding a product to be proposed, deciding a sales promotion method, deciding a purchasing method to be proposed, and deciding a form of use to be proposed. Examples of sales promotion methods include displaying an advertisement on a Web page, making a phone call, sending a direct mail by post, sending an e-mail, and making a house call. Examples of purchasing methods include lump-sum cash payment, loan, and lease. Examples of forms of use include purchasing, lease, and sharing.

According to one aspect of this disclosure, the characteristic relating to the consumption behavior of the inference target user is inferred from the behavioral history information on the inference target user, and an effective action can be inferred according to the inferred characteristic relating to the consumption behavior of the inference target user. Thus, an action effective for the inference target user can be performed, and the effect of the action performed on the inference target user can be enhanced.

In one aspect of this disclosure, an action that is inferred to be effective for the inference target user may be acquired based on inferred values of evaluations of a plurality of actions by inputting the inferred value of the characteristic relating to the consumption behavior of the inference target user into a second learned model and acquiring the inferred values of evaluations of the actions as an output. The second learned model is a model that has been learned using second learning data about a plurality of learning target users that has, as an input, a characteristic relating to the consumption behavior of each learning target user and, as an output, evaluations of a plurality of actions given by the learning target user.

Alternatively, an action that is inferred to be effective for the inference target user may be acquired using the first learned model that has been learned using first learning data that has, as an input, the behavioral history information on each learning target user and, as an output, the characteristic relating to the consumption behavior of the learning target user and evaluations of a plurality of actions given by the learning target user. Specifically, an action that is inferred to be effective for the inference target user may be determined based on inferred values of evaluations of a plurality of actions by inputting the behavioral history information on the inference target user into the first learned model and acquiring the inferred values of evaluations of the actions along with the inferred value of the characteristic relating to the consumption behavior of the inference target user.

Evaluations of a plurality of actions given by the learning target user are acquired, for example, by a questionnaire survey, a survey of a purchase record, or a survey of a behavioral record. For example, when the action is deciding a sales promotion method, evaluations of a plurality of actions given by the learning target user are acquired by a questionnaire survey. For example, when the action is deciding a product to be proposed, evaluations of a plurality of actions given by the learning target user is acquired by a survey of products that the learning target user has purchased.

According to one aspect of this disclosure, an action that is inferred to be given a high evaluation by the inference target user can be identified. Thus, an action can be efficiently performed on the inference target user.

In one aspect of this disclosure, the first learning data of the first learned model may have, as an output, classification of the characteristic relating to the consumption behavior of the learning target user based on answers to a questionnaire given by the learning target user. In this case, an inferred value of classification of the characteristic relating to the consumption behavior of the inference target user may be acquired as an output in response to an input of the behavioral history information on the inference target user into the first learned model. Thus, even when the number of pieces of behavioral history information is in the order of ten thousand, characteristics relating to consumption behavior can be scaled down to the number of classified categories and the processing efficiency can be thereby increased.

In one aspect of this disclosure, the information processing method may include causing the first learned model to learn by the first learning data. Thus, for example, the first learned model can be caused to learn by new first learning data on a regular basis to thereby update the first learned model.

As other aspects, this disclosure can also be identified as an information processing device that executes the information processing method, a program that causes a computer to execute the process of the information processing method, and a non-transitory, computer-readable storage medium that stores this program.

In the following, embodiments of the present disclosure will be described based on the drawings. The configurations of the following embodiments are examples and the present disclosure is not limited to the configurations of the embodiments.

### First Embodiment

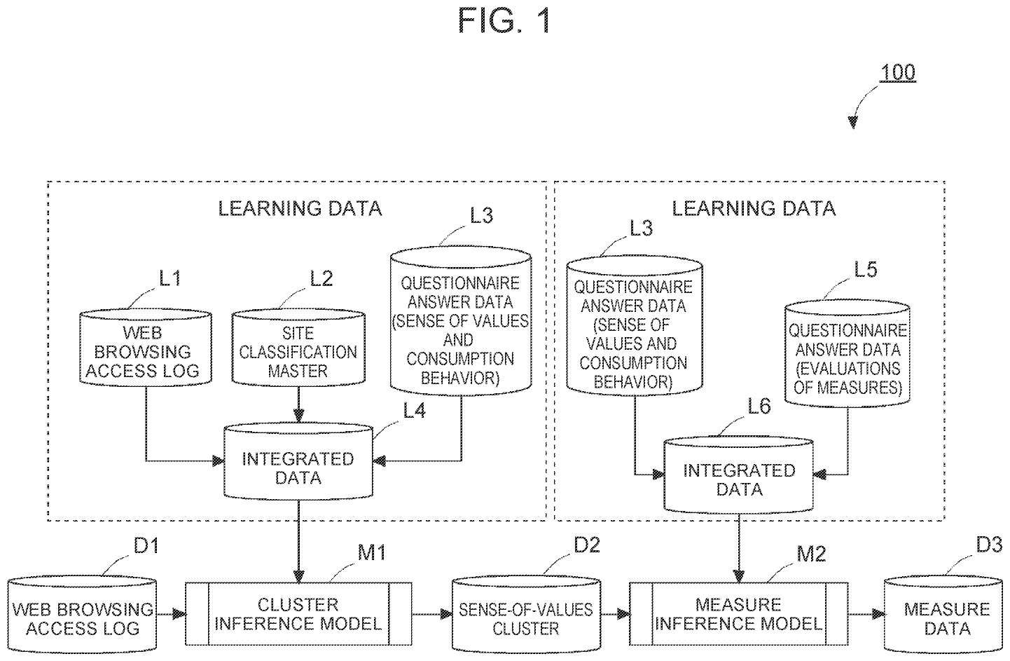

FIG. 1 is one example of a chart showing a flow of inference of an action in an action inference system 100 according to a first embodiment. The action inference system 100 is a system that infers an action effective for a user from behavioral history information on the user. In the first embodiment, it is assumed that the action is a sales promotion measure and that the behavioral history information is Web page browsing access log data. Thus, the action inference system 100 according to the first embodiment is a system that infers a sales promotion measure effective for the user from the Web page browsing access log data of the user.

The action inference system 100 uses a cluster inference model M1 and a measure inference model M2. The cluster inference model M1 is a model that infers a characteristic relating to the consumption behavior of the user from Web browsing access log data D1 of the user. Examples of the characteristic relating to the consumption behavior of the user include a sense of values about a product or a service to be purchased and a tendency of consumption behavior. Examples of the sense of values about a product or a service to be purchased include whether the user attaches importance to the brand, functionality, cost performance, or being ecological. Examples of the tendency of consumption behavior include a tendency in terms of the time taken to make a purchase, such as whether the user makes a quick decision or a deliberate decision, and a tendency in terms of the consideration method, such as whether the user decides by himself or herself or asks someone's opinion. In the first embodiment, the characteristic relating to the consumption behavior of the user is classified into one of a predetermined number of combinations of the sense of values and the tendency of consumption behavior. Hereinafter, the classification of the characteristic relating to the user will be referred to as a sense-of-values cluster. Thus, in the first embodiment, the cluster inference model M1 is a model for inferring a sense-of-values cluster D2 of the user from the Web browsing access log data D1 of the user. The measure inference model M2 is a model for inferring measure data D3 that is data of measures effective for the user from the sense-of-values cluster D2.

Both the cluster inference model M1 and the measure inference model M2 are learned models. The cluster inference model M1 has been learned by using, as learning data, integrated data L4 that is created from Web browsing access log data L1 of a learning target user, a site classification master L2, and data L3 of answers to a questionnaire on a sense of values and consumption behavior given by the learning target user. The measure inference model M2 has been learned by using, as learning data, integrated data L6 that is created from the data L3 of answers to a questionnaire on a sense of values and consumption behavior and data L5 of answers to a questionnaire on evaluations of measures. The cluster inference model M1 is one example of the “first learned model.” The measure inference model M2 is one example of the “second learned model.”

The Web browsing access log data L1, D1 are information on a history of Web pages that the user has accessed and browsed using a predetermined user terminal. The Web browsing access log data L1, D1 include, for example, user identification information, access date and time, URLs accessed, and the number of accesses. The Web browsing access log data L1, D1 are collected by, for example, a predetermined organization that provides a browser, and can be acquired from that organization.

The site classification master L2 is a master that defines classification of Websites. The site classification master L2 is disclosed by, for example, a predetermined organization. The site classification master L2 is used to identify the category of each Web page shown in each of the Web browsing access log data L1, D1. The questionnaire answer data L3, L5 are data of answers to a questionnaire that have been collected, for example, through the Web by an organization that manages the action inference system 100 or a predetermined questionnaire conducting organization. The questionnaire is conducted on each user at a predetermined timing.

The Web browsing access log data is data reflecting the sense of values and the tendency of the consumption behavior of the user, and is data showing objective facts. In the first embodiment, the sense-of-values cluster of the user is inferred from the Web browsing access log data, and data of effective measures are inferred from the inferred sense-of-values cluster of the user, so that measures according to the sense of values and the tendency of the consumption behavior of the user can be implemented. Thus, the influence of the measures over the consumption behavior of the user can be enhanced.

The Web browsing access log data is often collected in real time by, for example, a predetermined organization that provides a browser, and therefore this data is relatively easy to collect. Thus, using the Web browsing access log data can keep down the manpower cost and the monetary cost involved in collecting information and allows the action inference system 100 to be easily established.

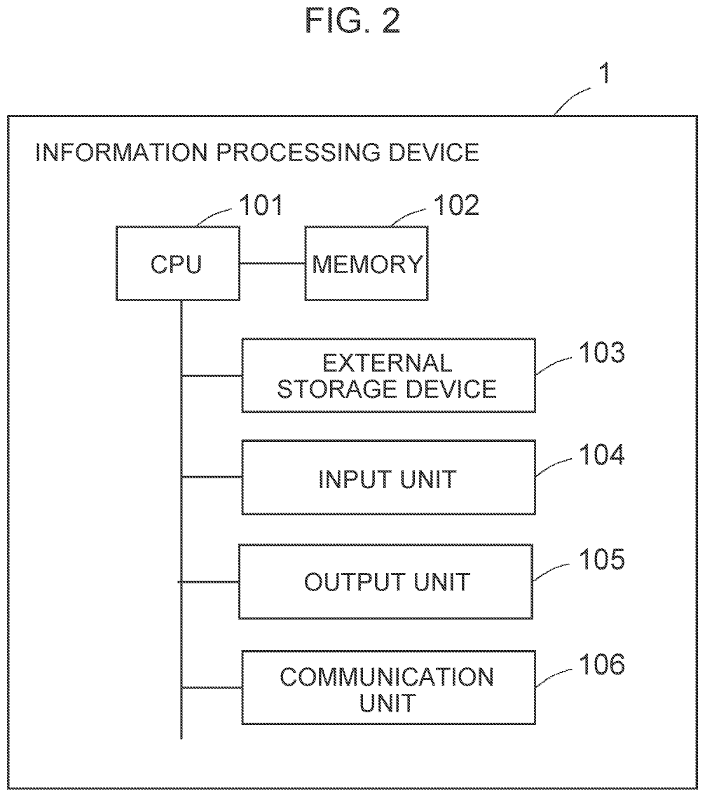

FIG. 2 is a chart showing one example of the hardware configuration of an information processing device 1. The information processing device 1 is a device that performs an inference process of the action inference system 100. The information processing device 1 is, for example, a dedicated computer, such as a server, or a general-purpose computer, such as a personal computer (PC). The hardware configuration of the information processing device 1 includes a central processing unit (CPU) 101, a memory 102, an external storage device 103, an input unit 104, an output unit 105, and a communication unit 106. The memory 102 and the external storage device 103 are storage media that can be read by a computer.

The external storage device 103 stores various programs and data that is used by the CPU 101 to execute the programs. The external storage device 103 is, for example, an erasable programmable ROM (EPROM) or a hard disk drive. As the programs retained by the external storage device 103, for example, an operating system (OS), an action inference program, and various other application programs are retained. The action inference program is a program for inferring actions effective for a user from the behavioral history information on the user.

The memory 102 is a storage device that provides a storage area and a work area in the CPU 101 for loading a program stored in the external storage device 103, and that is used as a buffer. Examples of the memory 102 include semiconductor memories such as a read-only memory (ROM) and a random-access memory (RAM).

The CPU 101 executes various processes by loading the OS and the various application programs retained in the external storage device 103 onto the memory 102 and executing them. The number of the CPU 101 is not limited to one, and more than one CPU 101 may be provided. The CPU 101 is one example of the “control unit” of the “information processing device.”

The input unit 104 is an input device, for example, a keyboard or a pointing device, such as a mouse. Signals input from the input unit 104 are output to the CPU 101. The output unit 105 is an output device, such as a display or a printer. The output unit 105 outputs information in response to an input of signals from the CPU 101. The input unit 104 and the output unit 105 may be a voice input device and a voice output device, respectively.

The communication unit 106 is an interface for inputting and outputting information through a network. The communication unit 106 may be an interface that connects to a wired network or an interface that connects to a wireless network. Examples of the communication unit 106 include a network interface card (NIC) and a wireless circuit. The hardware configuration of the information processing device 1 is not limited to that shown in FIG. 2.

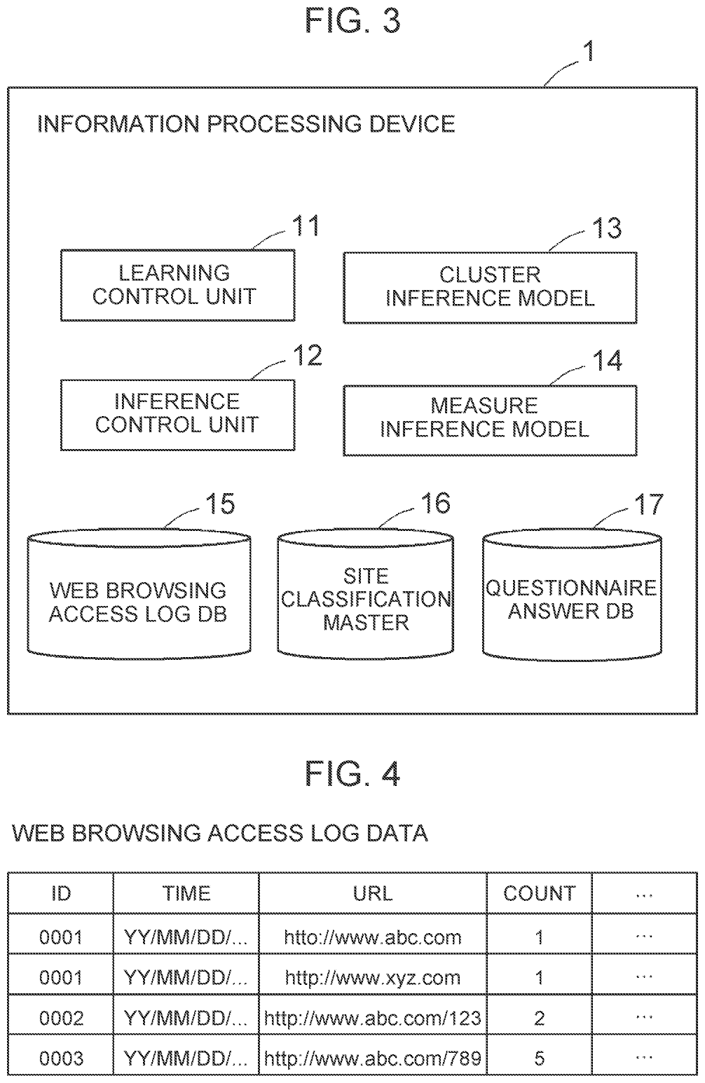

FIG. 3 is a chart showing one example of the functional configuration of the information processing device 1. The information processing device 1 includes, as functional components, a learning control unit 11, an inference control unit 12, a cluster inference model 13, a measure inference model 14, a Web browsing access log database (DB) 15, a site classification master 16, and a questionnaire answer DB 17. These functional components are realized, for example, by the CPU 101 of the information processing device 1 executing an action inference program.

The learning control unit 11 performs processes of creating and updating the cluster inference model 13 and the measure inference model 14. In both creating and updating the cluster inference model 13 and the measure inference model 14, the learning control unit 11 acquires learning data and inputs the learning data into the cluster inference model 13 and the measure inference model 14 to cause these models to learn the learning data. The learning data is acquired by collecting the Web browsing access log data L1 and the questionnaire answer data L3, L5 corresponding to a predetermined period and creating the integrated data L4, L6. The period for which the learning data is acquired is an arbitrary period, for example, one month to one year. The period for which the learning data is acquired for creating the cluster inference model 13 and the measure inference model 14 and that for updating these models may be the same or different from each other.

The learning control unit 11 updates the cluster inference model 13 and the measure inference model 14 at a predetermined timing. The cluster inference model 13 and the measure inference model 14 are updated at a timing of, for example, a predetermined cycle, occurrence of a predetermined event, or an input of a command to learn. The cycle of updating the cluster inference model 13 and the measure inference model 14 is set to an arbitrary period, for example, from one month to one year. The cluster inference model 13 and the measure inference model 14 may be updated at the same timing or each model may be updated at an independent timing. The details of learning of the cluster inference model 13 and the measure inference model 14 will be described later.

For example, when a command to start inference is input, the inference control unit 12 starts to infer an action. The command to start inference is input from a user terminal via a network, for example, through the input unit 104. Specifically, the inference control unit 12 acquires Web browsing access log data corresponding to a predetermined period. The Web browsing access log data to be acquired is, for example, the latest data. For each user included in the acquired Web browsing access log data, the inference control unit 12 creates input data for the cluster inference model 13. The input data for the cluster inference model 13 is, for example, scores given to the number of accesses, the access frequency, the Web page browsing time, etc. of one user for each category of Web pages that the user has browsed. The inference control unit 12 inputs the created input data into the cluster inference model 13 and acquires an inferred value of the sense-of-values cluster D2 for each user. Then, the inference control unit 12 inputs the inferred value of the sense-of-values cluster D2 acquired from the cluster inference model 13 into the measure inference model 14 to acquire an inferred value of an evaluation of each measure. The inference control unit 12 makes a list of a predetermined number of measures that rank high in the inferred value of evaluation and outputs the list. Hereinafter, the list of measures thus output will be referred to as a list of proposed measures. In the first embodiment, one list of proposed measures is output for each user. The list of proposed measures is, for example, output from the output unit 105 or sent to the user terminal via a network according to the command to start inference. The details of the inference process will be described later.

Both the cluster inference model 13 and the measure inference model 14 are learned models. When given an input value, the cluster inference model 13 and the measure inference model 14 perform predetermined calculations and output the calculation result as an output value. In the first embodiment, the cluster inference model 13 has learned so as to output an inferred value of the sense-of-values cluster D2 as an output value in response to an input value based on the Web browsing access log data. The measure inference model 14 has learned so as to output an inferred value of an evaluation of each measure as an output value in response to an input value of an inferred value of the sense-of-values cluster D2.

Both the cluster inference model 13 and the measure inference model 14 are machine learning models that perform supervised learning, such as neural network models, logistic regression models, tree models, Bayesian models, or time-series models. However, the cluster inference model 13 and the measure inference model 14 are not limited to a specific machine learning model. The learning method of the cluster inference model 13 and the measure inference model 14 is also not limited to a specific learning method. Further, the cluster inference model 13 and the measure inference model 14 may be machine learning models of the same type or different types.

For example, a process in the case where the cluster inference model 13 and the measure inference model 14 have a neural network is as follows. Hereinafter, the cluster inference model 13 and the measure inference model 14 will be collectively referred to as an inference model. A parameter matrix {xi, i=1, 2, . . . , N} is input into the inference model. The inference model executes a convolution process of performing a product-sum operation on the input parameter matrix with a weight coefficient {wi, j, 1 (where j is a value from 1 to the number M of elements to be convoluted, and 1 is a value from 1 to the number L of layers)}, an activation function that determines the result of the convolution process, and a pooling process that is a process of eliminating part of the determination result of the activation function for the convolution process. The inference model repeatedly executes these processes across the layers L, from an input layer into which the parameter matrix is input up to a fully connected layer at the top, and outputs an output parameter (or an output parameter matrix) {yk, k=1, . . . , P} in the fully connected layer at the final stage. In learning by a supervised model, an output parameter (output value) and solution data (label) are compared and an error is calculated. The error propagates backward across the layers of the neural network, from the fully connected layer at the top to the input layer, and the weight coefficient is adjusted. When a new parameter matrix is input into the learned inference model, the inference model outputs an output parameter in response to the input parameter matrix.

Each of the Web browsing access log DB 15, the site classification master 16, and the questionnaire answer DB 17 is created in a storage area of the external storage device 103. The Web access log DB 15 stores Web browsing access log data. The site classification master 16 stores a master that defines categories of Websites. The questionnaire answer DB 17 stores data of answers to a questionnaire on a sense of values and a tendency of consumption behavior and data of answers to a questionnaire on an evaluation of each measure. The details of these pieces of data will be described later.

Each or some of the functional components of the information processing device 1 shown in FIG. 3 may be realized by processing by another device. For example, one information processing device 1 may include the learning control unit 11, the inference control unit 12, the Web browsing access log DB 15, the site classification master 16, and the questionnaire answer DB 17, and another information processing device 1 may include the cluster inference model 13 and the measure inference model 14, and both information processing devices 1 may perform the processes of the action inference system 100 in cooperation with each other.

Description of Data

FIG. 4 to FIG. 7 illustrate the pieces of data that are used in the action inference system 100. FIG. 4 is one example of the Web browsing access log data. The Web browsing access log data includes, for example, user identification information, access date and time, the URLs of Web pages accessed, and the number of accesses. The Web browsing access log data is, for example, sent by a browser to an organization that provides the browser when a Web page is accessed through the browser. The user identification information included in the Web browsing access log data is automatically given by the organization that provides the browser. It is identification information that is used within the scope of jurisdiction of the organization that provides the browser, and is not such identification information as allows the user to be individually identified.

The Web browsing access log data may be, for example, acquired by the learning control unit 11 on a predetermined cycle from an organization holding the Web browsing access log data and stored in the Web access log DB 15. Alternatively, the learning control unit 11 may acquire the Web access log data corresponding to the latest predetermined period from a predetermined organization at the time of learning of the cluster inference model 13 and the measure inference model 14. Further, the inference control unit 12 may acquire the Web access log data corresponding to the latest predetermined period from a predetermined organization, for example, upon an input of a command to start inference. The information included in the Web browsing access log data is not limited to the information included in the example shown in FIG. 4.

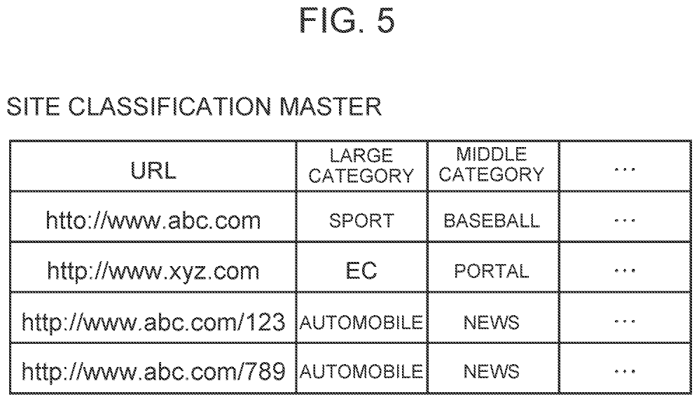

FIG. 5 is one example of the site classification master. The site classification master is disclosed by, for example, the organization that provides the browser, and is acquired from that organization and stored in the site classification master 16 in advance by the learning control unit 11. The site classification master includes, for example, correspondence between URLs and a large category, a middle category, etc. of classification. By using the site classification master, the category of each Web page accessed that is included in the Web browsing access log data can be identified, and for example, the number of accesses and the access frequency can be calculated for each category. The site classification master is updated on a predetermined cycle, and therefore the learning control unit 11 acquires the site classification master from the disclosing organization on a predetermined cycle to update the site classification master 16. The information included in the site classification master is not limited to the information included in the example shown in FIG. 5.

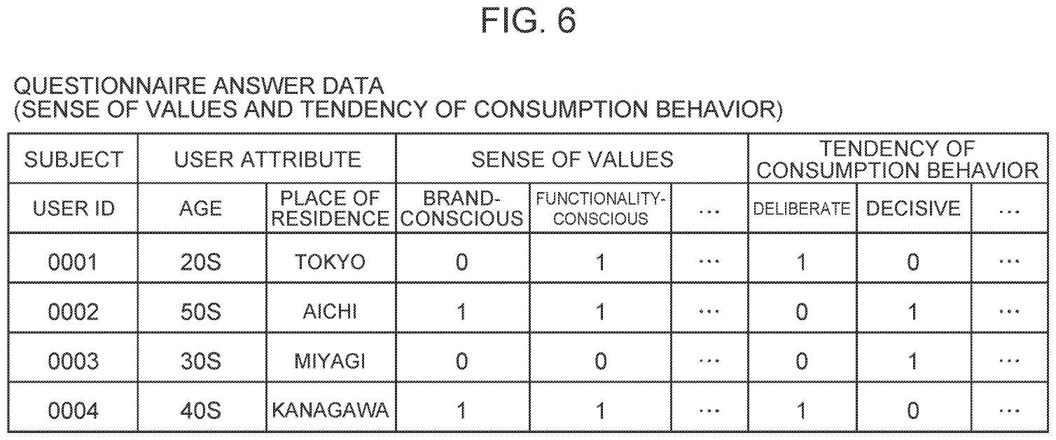

FIG. 6 is one example of the data of answers to a questionnaire on a sense of values and a tendency of consumption behavior. The data of answers to the questionnaire on a sense of values and a tendency of consumption behavior is collected from the user terminal through the Web. The data of answers to the questionnaire on a sense of values and a tendency of consumption behavior is retained by an organization that has conducted the questionnaire, and the learning control unit 11 acquires the data of answers to the questionnaire from that organization. In some cases, the organization that conducts the questionnaire is the same as the organization that manages the action inference system 100.

The questionnaire on a sense of values and a tendency of consumption behavior includes, for example, one or more questions about the attributes of a user, a question about a sense of values about consumption, and a question about the tendency of consumption behavior. The form of answering each question is such that, for example, the user selects one of multiple options that applies to himself or herself. For example, the answer data shown in FIG. 6 includes user identification information, user attributes, answers to a question about a sense of values, and answers to a question about a tendency of consumption behavior. The user identification information is automatically given by the organization that provides the browser. When Web pages are accessed from one user terminal using the same browser, the same user identification information is used. Therefore, user identification information included in the answer data shown in FIG. 6 and user identification information included in the Web browsing access log data are the same identification information if the user terminal is the same. Thus, the Web browsing access log data and the questionnaire answer data can be linked to each other by the user identification information.

The data of the answers to the questionnaire on a sense of values and a tendency of consumption behavior shown in FIG. 6 include options for each of the answer to the question about a sense of values and the answer to the question about a tendency of consumption behavior. A flag is indicated in the field of each option that the users have selected. Specifically, the example shown in FIG. 6 is an example of answers in the case where a questionnaire is conducted that includes options “brand-conscious,” “functionality-conscious,” etc. for the question about a sense of values about purchasing, for example, a question “Which factor do you attach importance to in making a purchase?,” and the options “deliberate,” “decisive,” etc. for the question about a tendency of consumption behavior, for example, a question “What is your tendency in deciding to make a purchase?” The questionnaire on a sense of values and a tendency of consumption behavior and the data of answers to the questionnaire are not limited to the example illustrated in FIG. 6.

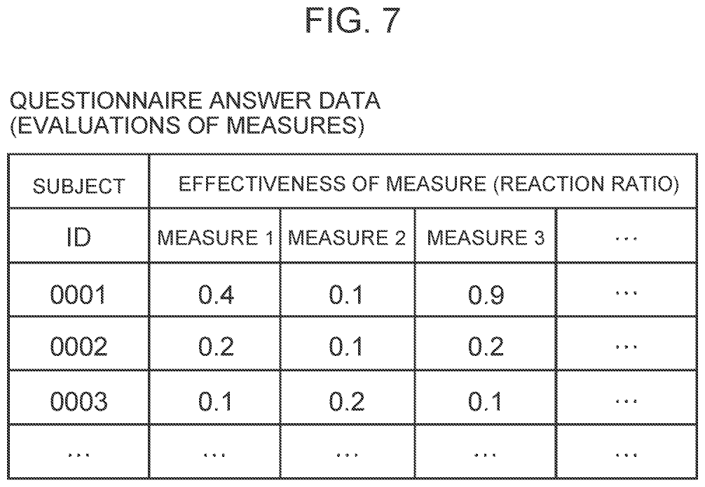

FIG. 7 is one example of the data of answers to a questionnaire on evaluations of measures. The data of answers to the questionnaire on evaluations of measures is collected from the user terminal through the Web. The data of answers to the questionnaire on evaluations of measures is retained by an organization that has conducted the questionnaire, and the learning control unit 11 acquires the data of answers to the questionnaire from that organization. The organization that conducts the questionnaire on evaluations of measures and the organization that conducts the questionnaire on a sense of values and a tendency of consumption behavior may be the same organization or different organizations.

The questionnaire on evaluations of measures includes, for example, questions about evaluation of each measure. Thus, the data of answers to the questionnaire on evaluations of measures is evaluations of the respective measures. In the example shown in FIG. 7, a reaction ratio of the user for each measure is used as the evaluation value of the measure. The reaction ratio of the user for a measure is, for example, a ratio of the number of times that the user answers he or she has taken some action regarding a product or a service covered by the measure in response to the measure, relative to the number of times that measure has been implemented. Examples of actions regarding a product or a service covered by a measure include searching for or browsing a Web page about the product or the service, visiting the shop to consider the product or the service, and purchasing the product or the service. The questionnaire on evaluations of measures and the data of answers to the questionnaire are not limited to the example illustrated in FIG. 7.

Learning and Inference of Learned Model

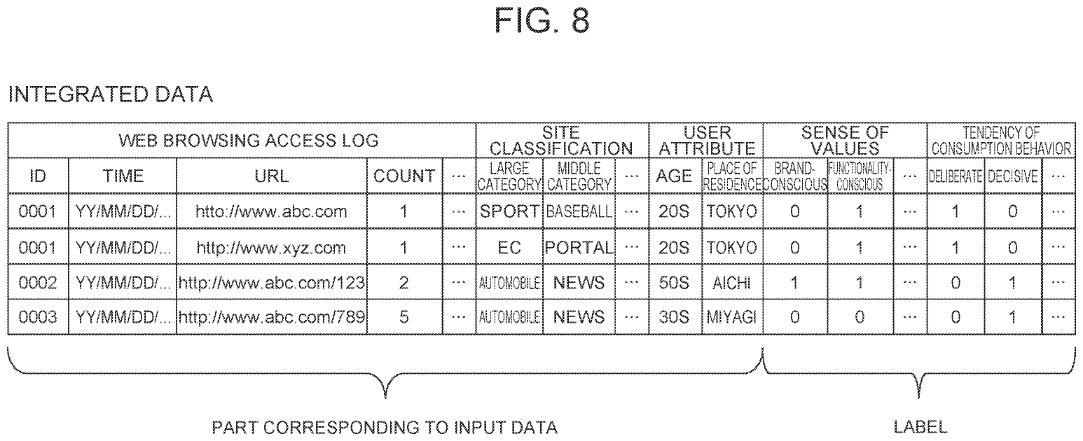

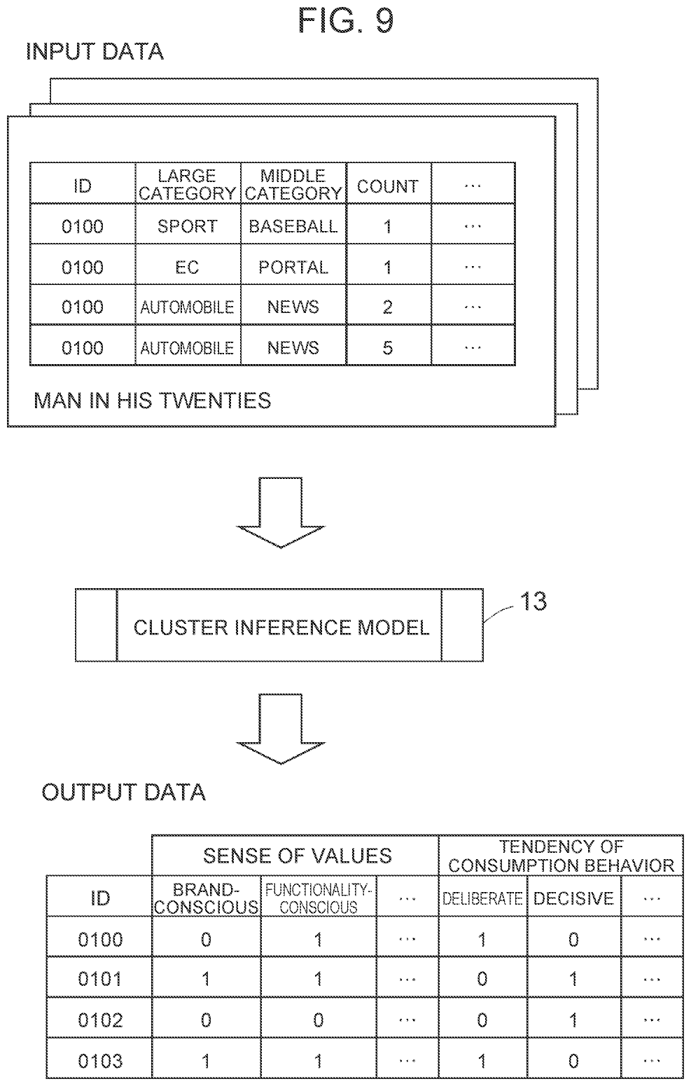

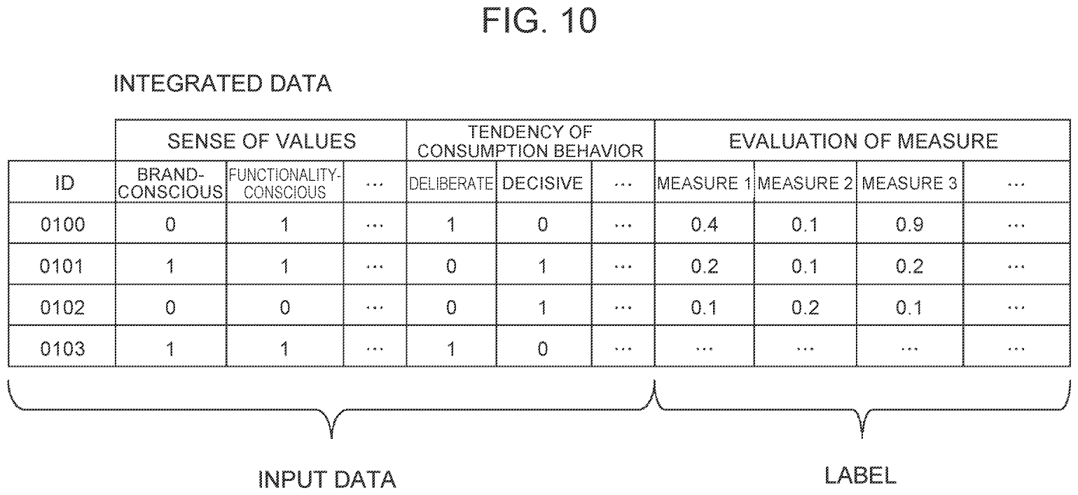

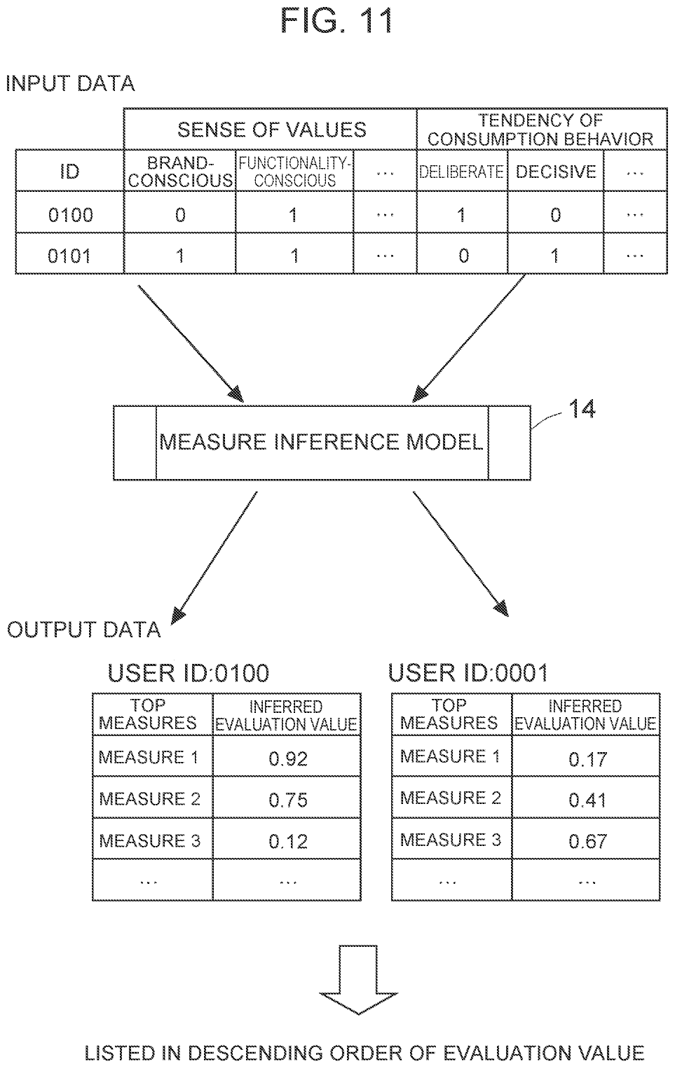

FIG. 8 and FIG. 9 are tables illustrating learning of the cluster inference model 13 and inference by the cluster inference model 13. FIG. 10 and FIG. 11 are tables illustrating learning of the measure inference model 14 and inference by the measure inference model 14. Hereinafter, a user who is a target of learning data will be referred to as a learning target user. A user who is a target of inference will be referred to as an inference target user.

FIG. 8 is one example of integrated data that serves as learning data for the cluster inference model 13. The learning control unit 11 creates the integrated data by integrating the Web browsing access log data (see FIG. 4), the site classification master (see FIG. 5), and the data of answers to the questionnaire on a sense of values and a tendency of consumption behavior (see FIG. 6) corresponding to a predetermined period. In the example shown in FIG. 8, one piece of integrated data is created by linking, to one piece of Web browsing access log data, a record of the site classification master corresponding to the category of the URL and the data of answers to a questionnaire having the same user identification information.

Data corresponding to user identification information that is present in only either the Web browsing access log data or the data of answers to the questionnaire on a sense of values and a tendency of consumption behavior is excluded from targets of learning data. That is, a user who is present in both the Web browsing access log data and the data of answers to the questionnaire on a sense of values and a tendency of consumption behavior that correspond to a predetermined period and have been acquired for learning data is a learning target user of the cluster inference model 13.

Of the integrated data, the part of the Web browsing access log data, the part of the site classification master, and the part of the user attributes included in the data of answers to the questionnaire on a sense of values and a tendency of consumption behavior are parts corresponding to input data of the learning data of the cluster inference model 13. The part of the options included in the data of answers to the questionnaire on a sense of values and a tendency of consumption behavior is a label of the learning data of the cluster inference model 13.

FIG. 9 is a chart showing one example of input data and output data in learning of the cluster inference model 13. The learning control unit 11 creates input data for the cluster inference model 13 in learning from the integrated data. For example, the input data is acquired as follows.

The learning control unit 11 integrates the parts of the integrated data that correspond to the input data for each identification information of learning target users. Therefore, one piece of input data is created for each learning target user. The learning control unit 11 acquires, from the parts of the integrated data of each learning target user that corresponds to the input data, the number of times a Web page is accessed, the access frequency, an average browsing time, etc., for example, for each category of Web pages. Of the categories defined by the site classification master, one of the large categories, a combination of the large category and the middle category, and a finer category is used as the category of Web pages, and the fineness of classification of categories can be arbitrarily set.

The learning control unit 11 gives a score to each category based on the accesses, the access frequency, the average browsing time, etc. of all categories. Scores are given such that, for example, a category in which the learning target user has higher interest and concern gets a higher score and that a category in which the learning target user has lower interest and concern gets a lower score. As input data, the learning control unit 11 acquires the scores on all categories and age and gender that are user attributes.

When the input data is input into the cluster inference model 13, for example, output data in a format similar to the format of the data of answers to the questionnaire on a sense of values and a tendency of consumption behavior is acquired for each learning target user. This output data shows an inferred value of the sense-of-values cluster of each learning target user. In learning of the cluster inference model 13, learning is performed by repeating, a predetermined number of times, a process of comparing a value of the output of the cluster inference model 13 and a value of the part of the integrated data corresponding to the label and then adjusting a parameter of the cluster inference model 13 so as to reduce the difference between the values.

When acquiring an inferred value of the sense-of-values cluster using the cluster inference model 13, the inference control unit 12 acquires Web browsing access log data corresponding to a predetermined period. A user included in the Web browsing access log data acquired by the inference control unit 12 is an inference target user.

In the same manner as creating the input data for learning, the inference control unit 12 creates input data as shown in FIG. 9 based on the acquired Web browsing access log data and site classification master. Since information on the user attributes such as age and gender is not included in the Web browsing access log data, data indicating “unknown” or “null” is used as user attribute information in the input data for inference.

The inference control unit 12 inputs the created input data into the cluster inference model 13 and acquires output data of the cluster inference model 13. The output data of the cluster inference model 13 is, for example, the probability of each option in the questionnaire on a sense of values and a tendency of consumption behavior being selected, in a format similar to the format of the data of answers to the questionnaire on a sense of values and a tendency of consumption behavior as shown in FIG. 9. In the data of answers to the questionnaire on a sense of values and a tendency of consumption behavior used as the label in learning, the probability of each option being selected is from 1 to 0. In the output data of the cluster inference model 13 for inference, the value is from 0 to 1 to indicate the probability of each option being selected. Therefore, the inference control unit 12 represents the probability of each option being selected as one of the two values of 0 and 1 using a predetermined threshold value. As a result, the inference control unit 12 obtains an inferred value of the sense-of-values cluster of the inference target user as a combination of options that have the value 1. For example, the sense-of-values cluster of an inference target user for whom the value in the field “brand-conscious” in the item “sense of values” is 1 and the value in the field “deliberate” in the item “tendency of consumption behavior” is 1 is “brand-conscious and deliberate.”

FIG. 10 is one example of the integrated data that serves as the learning data for the measure inference model 14. The learning control unit 11 creates the integrated data by integrating the data of answers to the questionnaire on a sense of values and a tendency of consumption behavior (see FIG. 6) and the data of answers to the questionnaire on evaluations of measures (see FIG. 7) that correspond to a predetermined period. In the example shown in FIG. 10, one piece of integrated data is created by linking the pieces of data of answers to the respective questionnaires having the same user identification information to each other.

Data corresponding to user identification information that is present in only either the data of answers to the questionnaire on a sense of values and a tendency of consumption behavior or the data of answers to the questionnaire on evaluations of measures is excluded from targets of learning data. That is, a user who is present in both the data of answers to the questionnaire on a sense of values and a tendency of consumption behavior and the data of answers to the questionnaire on evaluations of measures that correspond to a predetermined period and have been acquired for learning data is a learning target user of the measure inference model 14.

Of the integrated data, the part of the data of answers to the questionnaire on a sense of values and a tendency of consumption behavior is the part corresponding to input data of the learning data of the measure inference model 14. The part of the data of answers to the questionnaire on evaluations of measures is the label of the learning data of the measure inference model 14.

FIG. 11 is a chart showing one example of the input data and the output data for the measure inference model 14. The input data for the measure inference model 14 for learning is the data of answers to the questionnaire on a sense of values and a tendency of consumption behavior that corresponds to a predetermined period.

When the input data is input into the measure inference model 14, for example, an inferred value of an evaluation value of each measure is acquired as output data for each learning target user. In learning of the measure inference model 14, learning is performed by repeating, a predetermined number of times, a process of comparing a value of the output data of the measure inference model 14 and a value of the part of the integrated data that corresponds to the label and then adjusting a parameter of the measure inference model 14 so as to reduce the difference between the values.

When acquiring the inferred value of the evaluation value of each measure using the measure inference model 14, the inference control unit 12 inputs the inferred value of the sense-of-values cluster that has been acquired as the output data of the cluster inference model 13 into the measure inference model 14. As the output data from the measure inference model 14, an inferred value of the evaluation value of each measure for the inference target user is acquired. For example, when a higher evaluation value means a higher evaluation, the inference control unit 12 rearranges the measures in the output data of each user in descending order of the inferred value of the evaluation value, makes a list of a predetermined number of top measures, and outputs the list.

Flow of Process

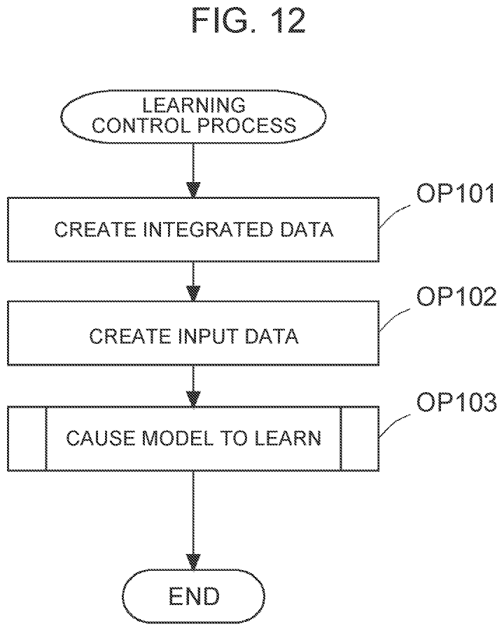

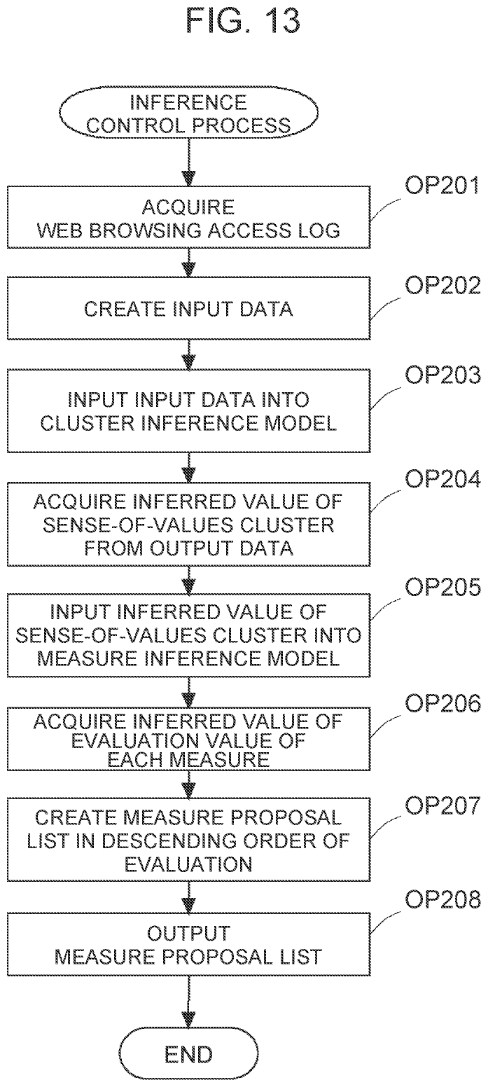

FIG. 12 is one example of a flowchart of a learning process of the cluster inference model 13 and the measure inference model 14 in the action inference system 100. The process shown in FIG. 12 is executed, for example, upon an input of a command to start learning or on a predetermined cycle. The subject that executes the process shown in FIG. 12 is the CPU 101 of the information processing device 1 but, for convenience, the process will be described with a functional component as the subject. The same applies to FIG. 13. The process of FIG. 12 is executed for each of the cluster inference model 13 and the measure inference model 14. In FIG. 12, the cluster inference model 13 and the measure inference model 14 are referred to simply as a learned model, without being distinguished from each other.

In OP101, the learning control unit 11 creates the integrated data (see FIG. 8 and FIG. 10). In OP102, the learning control unit 11 creates input data for the learned model from the integrated data (see FIG. 9 and FIG. 11). In OP103, the learning control unit 11 inputs the created input data and the label into the learned model to cause the learned model to learn. When learning of the learned model has completed, the process shown in FIG. 12 ends.

FIG. 13 is one example of a flowchart of the inference control process in the action inference system 100. The process shown in FIG. 13 is executed, for example, upon an input of a command to start inference or on a predetermined cycle.

In OP201, the inference control unit 12 acquires Web browsing access log data corresponding to the latest predetermined period from a predetermined organization. In OP202, from the acquired Web browsing access log data, the inference control unit 12 creates input data for each inference target user to be input into the cluster inference model 13 (see FIG. 9). In OP203, the inference control unit 12 inputs the created input data into the cluster inference model 13. In OP204, the inference control unit 12 acquires an inferred value of the sense-of-values cluster of each inference target user from the output data of the cluster inference model 13.

In OP205, the inference control unit 12 inputs the inferred value of the sense-of-values cluster of each inference target user into the measure inference model 14. In OP206, the inference control unit 12 acquires the inferred value of the evaluation value of each measure of each inference target user as an output data of the measure inference model 14. In OP207, for each inference target user, the inference control unit 12 rearranges the measures in descending order of evaluation to create a list of proposed measures including a predetermined number of top measures. In OP208, the inference control unit 12 outputs the list of proposed measures for each inference target user. Then, the process shown in FIG. 13 ends.

The processes shown in FIG. 12 and FIG. 13 are examples, and changes can be made as necessary to the steps, the order in which the steps are executed, etc. according to the embodiment.

Workings and Effects of First Embodiment

According to the first embodiment, the sense of values and the tendency of consumption behavior of an inference target user are inferred from the Web browsing access log data of the inference target user, and further, sales promotion measures that are effective for the inference target user are inferred. Thus, sales promotion measures that are effective for the inference target user can be implemented and the efficiency of sales promotion can be thereby increased.

The learned model is used to infer the sense of values and the tendency of consumption behavior of the inference target user. The learned model can be acquired by purchasing a package of an unlearned model and causing the model to learn. The Web browsing access log data is relatively easy to obtain, as there are organizations that collect such data. According to the first embodiment, therefore, it is possible to easily infer the sense of values and the tendency of consumption behavior of the inference target user and infer sales promotion measures that are effective for the inference target user while keeping the manpower cost and the monetary cost down.

The Web browsing access log data of one user corresponding to a predetermined period is often a large amount of data. In the first embodiment, a statistical value of each category of Web pages is used as input data for the cluster inference model 13. Thus, the amount of data and the amount of processing can be reduced compared with when the Web browsing access log data is used as is as input data. Moreover, the output data of the cluster inference model 13 is used in the form of the sense-of-values cluster instead of being used as is, so that the amount of data input into the measure inference model 14 and the amount of processing can be reduced.

Modified Example

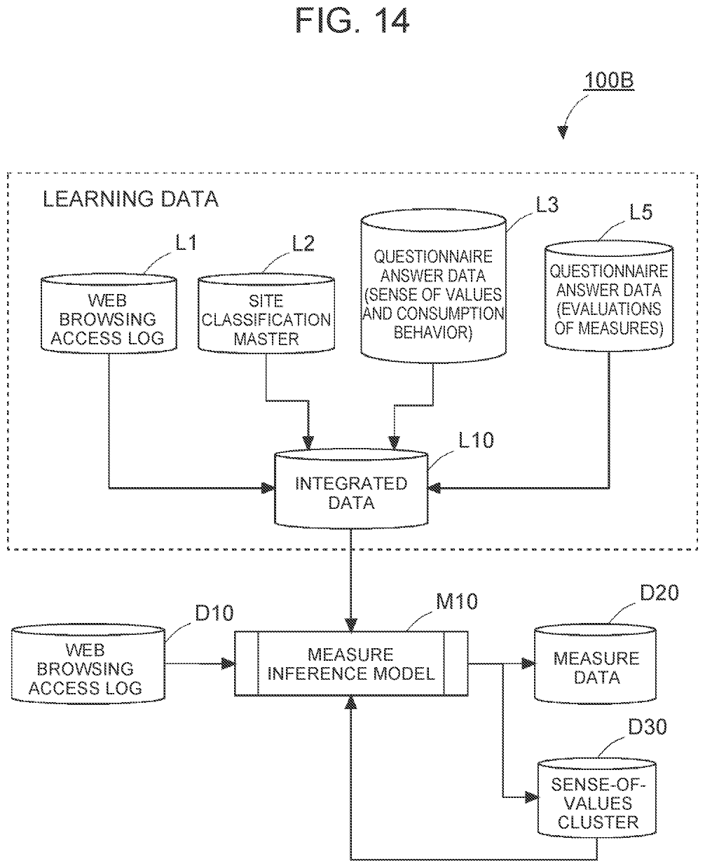

FIG. 14 is one example of a chart showing a flow of inference of an action in an action inference system 100B according to a modified example. While the action inference system 100 according to the first embodiment uses two learned models, in the modified example, only one learned model is used.

A measure inference model M10 in the modified example has, as an input, Web browsing access log data D10 and, as an output, measure data D20 and a sense-of-values cluster D30. The sense-of-values cluster D30 is fed back to the measure inference model M10 and used as an input value for inference of the measure data D20.

The learning data of the measure inference model M10 is acquired from Web browsing access log data L1, a site classification master L2, data L3 of answers to a questionnaire on a sense of values and a tendency of consumption behavior, and data L5 of answers to a questionnaire on evaluations of measures. The Web browsing access log data L1 and the site classification master L2 correspond to input data for learning data. The data L3 of answers to the questionnaire on a sense of values and a tendency of consumption behavior and the data L5 of answers to the questionnaire on evaluations of measures correspond to the label of the learning data.

The input data and the output data for the measure inference model M10 respectively have formats similar to those of the pieces of data of the same names that have been described in the first embodiment and are used as input data and output data.

According to the modified example, the sense-of-values cluster of the inference target user and actions effective for the inference target user can be inferred from the Web browsing access log data of the inference target user by using one learned model.

### Other Embodiments

The above embodiment is merely one example and the present disclosure can be implemented with changes made thereto as necessary within the scope of the gist of the disclosure.

In the first embodiment, the measure inference model 14 is used to infer measures form an inferred value of a sense-of-values cluster, but measures may be inferred without using the measure inference model 14. For example, one or more effective measures may be set in advance for each sense-of-values cluster.

Examples of information that can be used as the behavioral history information on a user include, other than Web browsing access log data, Web search log data, information on a history of purchasing products and services on the Web, and information on a history of video data played on the Web. The behavioral history information is not limited to information on behavior on the Web, and information on a history of behavior in the real world can also be used. Examples of information on a history of behavior in the real world include information on a history of visiting real shops and information on a history of purchasing products and services.

The action that can be inferred may be, in addition to sales promotion measures, decision of a product to be proposed, decision of a purchasing method to be proposed, decision of a method of use to be proposed, etc.

The processes and means described in this disclosure can be implemented in arbitrary combinations within such a range that no technical inconsistency arises.

A process that has been described as being performed by one device may be executed by a plurality of devices in cooperation with one another. Or processes that have been described as being performed by different devices may be executed by one device. Which function is realized in what hardware configuration (server configuration) in the computer system can be flexibly changed.

This disclosure can also be realized by supplying a computer with a computer program that includes functions described in the above embodiment, and by causing one or more processers of the computer to read and execute the program. Such a computer program may be provided to the computer by a non-transitory, computer-readable storage medium that can be connected to a system bus of the computer, or may be provided to the computer through a network. Examples of the non-transitory, computer-readable storage medium include arbitrary types of disks including magnetic disks (a Floppy® disk, a hard disk drive (HDD), etc.) and optical discs (a CD-ROM, a DVD disc, a Blu-ray disc, etc.), and arbitrary types of media suitable for storing electronic commands including a read-only memory (ROM), a random-access memory (RAM), an EPROM, an EEPROM, a magnetic card, a flash memory, and an optical card.

What is claimed is:

1. An information processing method comprising:
acquiring behavioral history information on an inference target user;
acquiring an inferred value of a characteristic relating to consumption behavior of the inference target user as an output in response to an input of the behavioral history information on the inference target user into a first learned model that has been learned using first learning data about a plurality of learning target users, the first learning data having, as an input, behavioral history information on each of the learning target users and, as an output, a characteristic relating to consumption behavior of the learning target user based on answers to a questionnaire given by the learning target user; and
based on the inferred value of the characteristic relating to the consumption behavior of the inference target user, outputting an action that is inferred to be effective for the inference target user.

2. The information processing method according to claim 1, further comprising acquiring inferred values of evaluations of a plurality of actions as an output in response to an input of the inferred value of the characteristic relating to the consumption behavior of the inference target user into a second learned model that has been learned using second learning data about the learning target users, the second learning data having, as an input, the characteristic relating to the consumption behavior of each of the learning target users and, as an output, evaluations of the actions given by the learning target user, wherein an action that is inferred to be effective for the inference target user is determined based on the inferred values of the evaluations of the actions.

3. The information processing method according to claim 1, wherein:
the first learning data of the first learned model has, as an input, the behavioral history information on each of the learning target users and, as an output, the characteristic relating to the consumption behavior of the learning target user and evaluations of a plurality of actions given by the learning target user;
as an output in response to an input of the behavioral history information on the inference target user into the first learned model, inferred values of evaluations of the actions are acquired along with the inferred value of the characteristic relating to the consumption behavior of the inference target user; and
an action that is determined to be effective for the inference target user is determined based on the inferred values of evaluations of the actions.

4. The information processing method according to claim 1, wherein:
the first learning data of the first learned model has, as an output, classification of the characteristic relating to the consumption behavior of each of the learning target users based on answers to the questionnaire given by the learning target user; and
as an output in response to an input of the behavioral history information on the inference target user into the first learned model, an inferred value of classification of the characteristic relating to the consumption behavior of the inference target user is acquired.

5. The information processing method according to claim 1, wherein the behavioral history information is Web page browsing access log data.

6. The information processing method according to claim 5, further comprising scoring the Web page browsing access log data in terms of a property of Web page browsing, for each category of Web pages, by using at least one of the number of accesses, an access frequency, and a browsing time, wherein the first learned model has, as an input, a score on the property of Web page browsing.

7. The information processing method according to claim 1, wherein the first learned model has, as an input for the learning data, attribute information on each of the learning target users in addition to the behavioral history information on the learning target user.

8. The information processing method according to claim 1, further comprising causing the first learned model to learn by the learning data.

9. An information processing device comprising a control unit that executes:
acquiring behavioral history information on an inference target user;
acquiring an inferred value of a characteristic relating to consumption behavior of the inference target user as an output in response to an input of the behavioral history information on the inference target user into a first learned model that has been learned using first learning data about a plurality of learning target users, the first learning data having, as an input, behavioral history information on each of the learning target users and, as an output, a characteristic relating to consumption behavior of the learning target user based on answers to a questionnaire given by the learning target user; and
based on the inferred value of the characteristic relating to the consumption behavior of the inference target user, outputting an action that is inferred to be effective for the inference target user.

10. The information processing device according to claim 9, wherein:
the control unit further executes acquiring inferred values of evaluations of a plurality of actions as an output in response to an input of the inferred value of the characteristic relating to the consumption behavior of the inference target user into a second learned model that has been learned using second learning data about the learning target users, the second learning data having, as an input, the characteristic relating to the consumption behavior of each of the learning target users and, as an output, evaluations of the actions given by the learning target user; and
based on the inferred values of evaluations of the actions, the control unit determines an action that is inferred to be effective for the inference target user.

11. The information processing device according to claim 9, wherein:
the first learning data of the first learned model has, as an input, the behavioral history information on each of the learning target users and, as an output, the characteristic relating to the consumption behavior of the learning target user and evaluations of a plurality of actions given by the learning target user;
as an output in response to an input of the behavioral history information on the inference target user into the first learned model, the control unit acquires inferred values of evaluations of the actions along with the inferred value of the characteristic relating to the consumption behavior of the inference target user; and
based on the inferred values of evaluations of the actions, the control unit determines an action that is inferred to be effective for the inference target user.

12. The information processing device according to claim 9, wherein:
the first learning data of the first learned model has, as an output, classification of the characteristic relating to the consumption behavior of each of the learning target users based on answers to the questionnaire given by the learning target user; and
as an output in response to an input of the behavioral history information on the inference target user into the first learned model, the control unit acquires an inferred value of classification of the characteristic relating to the consumption behavior of the inference target user.

13. The information processing device according to claim 9, wherein the behavioral history information is Web page browsing access log data.

14. The information processing device according to claim 13, wherein:
the control unit further executes scoring the Web page browsing access log data in terms of a property of Web page browsing, for each category of Web pages, by using at least one of the number of accesses, an access frequency, and a browsing time; and
the first learned model has, as an input, a score on the property of Web page browsing.

15. The information processing device according to claim 9, wherein the first learned model has, as an input for the learning data, attribute information on each of the learning target users in addition to the behavioral history information on the learning target user.

16. The information processing device according to claim 9, wherein the control unit further executes causing the first learned model to learn by the learning data.

17. A program that causes a computer to execute:
acquiring behavioral history information on an inference target user;
acquiring an inferred value of a characteristic relating to consumption behavior of the inference target user as an output in response to an input of the behavioral history information on the inference target user into a first learned model that has been learned using first learning data about a plurality of learning target users, the first learning data having, as an input, behavioral history information on each of the learning target users and, as an output, a characteristic relating to consumption behavior of the learning target user based on answers to a questionnaire given by the learning target user; and
based on the inferred value of the characteristic relating to the consumption behavior of the inference target user, outputting an action that is inferred to be effective for the inference target user.

18. The program according to claim 17, wherein:
the computer further executes acquiring inferred values of evaluations of a plurality of actions as an output in response to an input of the inferred value of the characteristic relating to the consumption behavior of the inference target user into a second learned model that has been learned using second learning data about the learning target users, the second learning data having, as an input, the characteristic relating to the consumption behavior of each of the learning target users and, as an output, evaluations of the actions given by the learning target user; and
based on the inferred values of evaluations of the actions, the computer determines an action that is inferred to be effective for the inference target user.

19. The program according to claim 17, wherein:
the first learning data of the first learned model has, as an input, the behavioral history information on each of the learning target users and, as an output, the characteristic relating to the consumption behavior of the learning target user and evaluations of a plurality of actions given by the learning target user;
as an output in response to an input of the behavioral history information on the inference target user into the first learned model, the computer acquires inferred values of evaluations of the actions along with the inferred value of the characteristic relating to the consumption behavior of the inference target user; and
based on the inferred values of evaluations of the actions, the computer determines an action that is inferred to be effective for the inference target user.

20. The program according to claim 17, wherein:
the first learning data of the first learned model has, as an output, classification of the characteristic relating to the consumption behavior of each of the learning target users based on answers to the questionnaire given by the learning target user; and
as an output in response to an input of the behavioral history information on the inference target user into the first learned model, the computer acquires an inferred value of classification of the characteristic relating to the consumption behavior of the inference target user.
